(19) United States
(12) Patent Application Publication
(10) Pub. No.: US 2016/0196093 A1
(43) Pub. Date: Jul. 7, 2016

(54) PROCESSING PRINT JOBS IN REVERSE ORDER

(71) Applicants: Aritra Bandyopadhyay, Boulder, CO (US); Edward Chatcavage, Longmont, CO (US); Justin Coulter, Longmont, CO (US); Thomas Kooh, Westminster, CO (US); David Ward, Broomfield, CO (US)

(72) Inventors: Aritra Bandyopadhyay, Boulder, CO (US); Edward Chatcavage, Longmont, CO (US); Justin Coulter, Longmont, CO (US); Thomas Kooh, Westminster, CO (US); David Ward, Broomfield, CO (US)

(73) Assignee: RICOH COMPANY, LTD., Tokyo (JP)

(21) Appl. No.: 14/591,141

(22) Filed: Jan. 7, 2015

(51) Int. Cl. G06F 3/12

(52) U.S. Cl. CPC G06F 3/1215; G06F 3/1203; G06F 3/1253

(57) ABSTRACT

System and methods for processing and printing print jobs in reverse order. In one embodiment, an apparatus for abnormal order printing includes a preprocess system of a print controller configured to receive a print job. The apparatus also includes a print order processor configured to determine a modified print order of logical pages for the print job. The apparatus further includes a RIP system configured to receive media information for the print job, to receive the logical pages of the print job in the modified order, and to assemble sheet sides using the media information as the logical pages are received in the modified order. The apparatus further includes a print engine configured to receive the sheet sides, and to mark physical media based on the sheet sides.

### FIELD OF THE INVENTION

The invention relates to the field of printing systems, and in particular, to efficient printing of print jobs.

### BACKGROUND

In the field of printing, it is generally desirable to maximize printing quality and printing speed at a printer. Delay that occurs between sending a print job to a printer and receiving the printed sheets of the print job is generally undesirable. Therefore, printer manufacturers strive to optimize the print controller that rasterizes the print job into bitmap data as well as the print engine that uses the bitmap data to mark a printable media such as paper.

For various reasons, it may be desirable in some circumstances to print a print job in abnormal order, such as in a reverse order or in a booklet format. As such, the sequential logical page order in the print job does not necessarily correspond to the desired printed order. The ability of a printer to print in the desired print order avoids the process of printing the print job in normal order and then re-sorting the order manually or with post-print equipment.

To print in an abnormal order, a print controller rasterizes the entire print job in normal order (e.g., page 1, 2, 3, . . . N), stores the rasterized pages on a disk, such as a rip spool, and then sends the rasterized pages to the print engine in the desired, abnormal order. However, this method of processing print jobs incurs significant delay between sending the print job to the printer and receiving the printed sheets because of the time it takes to first rasterize the entire print job in normal order. Thus, it remains a problem to efficiently print a print job in an order other than a normal order, such as a reversed order.

### SUMMARY

Embodiments described herein provide for processing print jobs in abnormal (e.g., reverse) order. The media configuration for an entire print job is analyzed to produce a job model that captures the relationship of which logical pages map to sheet sides for the print job before rasterizing the entire print job. The job model informs the rasterization order of logical pages such that sheet sides may be assembled in the abnormal order and immediately sent to the print engine for printing. This avoids having the entire print job rasterized in normal order and stored on a rip spool and therefore significantly reduces the time to begin physical output at the marking engine as well as the total time to process and print the print job in the requested abnormal order.

One embodiment is apparatus for abnormal order printing that includes a preprocess system of a print controller configured to receive a print job. The apparatus also includes a print order processor configured to determine a modified print order of logical pages for the print job. The apparatus further includes a RIP system configured to receive media information for the print job, to receive the logical pages of the print job in the modified order, and to assemble sheet sides using the media information as the logical pages are received in the modified order. The apparatus further includes a print engine configured to receive the sheet sides, and to mark physical media based on the sheet sides.

The above summary provides a basic understanding of some aspects of the specification. This summary is not an extensive overview of the specification. It is not intended to identify key or critical elements of the specification nor to delineate any scope of particular embodiments of the specification, or any scope of the claims. Its sole purpose is to present some concepts of the specification in a simplified form as a prelude to the more detailed description that is presented later. Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a printer in an exemplary embodiment.

FIG. 2 is a flow chart illustrating a method for abnormal order printing in an exemplary embodiment.

FIG. 3 illustrates an exemplary print job for printing in a reverse order.

FIG. 4 illustrates a processing system operable to execute a computer readable medium embodying programmed instructions to perform desired functions in an exemplary embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

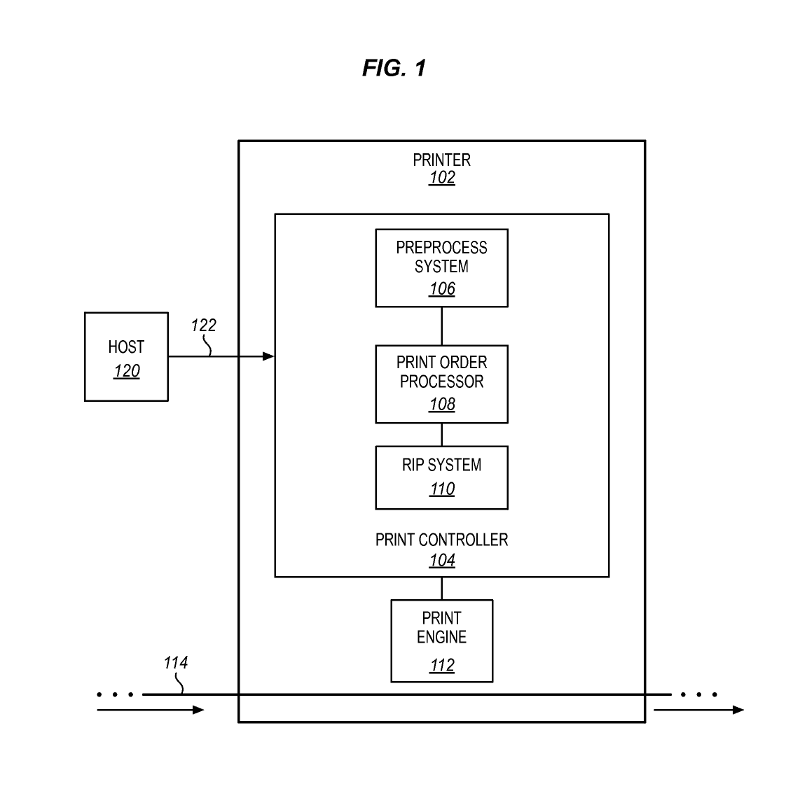

FIG. 1 is a block diagram of a printer 102 in an exemplary embodiment. Printer 102 includes a print controller 104 and a print engine 112. Print controller 104 receives incoming print jobs 122 from one or more host(s) 120, and transmits rasterized data for a print job to print engine 112. Print engine 112 may comprise any combination of printing machinery operable to mark a printable media 114 with the rasterized data. Print jobs 122 may include raw print data in a page description format such as PDL, Printer Control Language (PCL), PostScript data, etc. A print job may also include a job ticket that defines various characteristics of the print job, such as media information, page inserts, and page exceptions for a specified page range in the print job.

Print controller 104 may perform a number of data processing operations on print jobs 122 prior to print engine 112 marking the printable media 114. Print controller 104 includes preprocess system 106, print order processor 108, and Raster Image Processor (RIP) system 110. Preprocess system 106 is any system, component, or device operable to receive raw data for print jobs, and perform preprocessing on the raw data before the print jobs are interpreted, such as to segment the print jobs into pages. Preprocess system 106 may also store print jobs received from host 120 in a raw job spool (not shown). RIP system 110 is any system, component, or device operable to interpret, assemble, render, rasterize, or otherwise convert raw sheet sides for print jobs into sheet side bitmaps for the print jobs. RIP system 110 may render multiple pages or sheet sides concurrently so that the rasterizing process substantially matches an imaging rate of a production print engine operable to output printable media 114 in continuous web or cut-sheet form.

In previous print systems, when a print job is to be printed in any order other than the order of pages in the print job as received (e.g., an order different from a normal order such 1, 2, 3, . . . N), the logical pages of the print job are rasterized in the order they appear in the received print job for proper determination of which logical pages map to which sheet sides for the print job. Then, the rasterized print job is stored in a storage device, such as a rip spool, and de-spooled from the storage device in the desired order (e.g., abnormal order such as a reverse order N . . . 3, 2, 1). The print job is therefore ripped and spooled prior to printing for placement of rasterized logical pages in the correct order. However, as previously discussed, there is a significant delay in printing due to the time to first rasterize the entire print job in normal order before printing may begin.

Print controller 104 is therefore enhanced with print order processor 108 that is any system, component, or device configured to detect a print job that is to be printed in an abnormal order and to manage processing of the print job to avoid delay associated with rasterizing the entire print job first or storing the rasterized print job in a rip spool. An abnormal order may include any print job to be printed in an order that differs from the sequential order of logical pages and includes reverse order, booklet format, magazine format, etc. Thus, those of ordinary skill in the art will recognize that the operating concepts of the print order processor 108 described herein may apply to print jobs to be printed in various formats or abnormal print orders. Furthermore, it will be appreciated that, although shown in FIG. 1 as a separate, discrete component, print order processor 108 may direct, control, coordinate, or be configured within other components/processes of print controller 104, such as preprocess system 106 and RIP system 110.

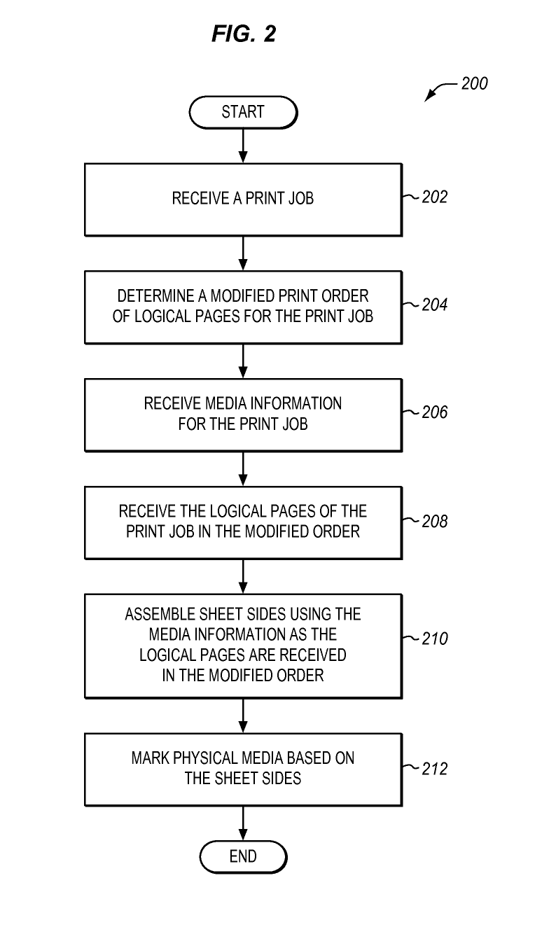

FIG. 2 is a flow chart illustrating a method 200 for abnormal order printing in an exemplary embodiment. The steps of the method 200 will be described with respect to printer 102 of FIG. 1, although one skilled in the art will understand that method 200 may be performed by other systems not shown. The steps of the method 200 described herein are not all inclusive and may include other steps not shown. The steps for the flow charts shown herein may also be performed in an alternative order.

At step 202, print controller 104 receives a print job. The print job may be accompanied with an associated job ticket that defines metadata for the print job, such as media information (e.g., size, type, color, weight), the number of logical pages on a sheet side (e.g., n-up printing configuration), plex (e.g., simplex or duplex), insert pages, page exceptions, etc. Additionally, some media information may be determined/collected by preprocess system 106 during segmentation/pagination of print data, such as a media size to be used if the job ticket does not specify or is overruled in settings of print controller 104.

At step 204, print order processor 108 determines a modified print order of logical pages for the print job. The abnormal order may be based on information specified in the print job, job ticket, user request, operator/printer settings, etc.

At step 206, RIP system 110 receives media information for the print job. The media information informs RIP system 110 as to which logical pages are to be placed on which sheet sides for the print job. For instance, media information in the job ticket may be analyzed for the number of logical pages, media size, plex, n-up configuration, and insert sheets, etc. to produce a job model that maps logical pages to sheet sides before the entire job is rasterized.

At step 208, RIP system 110 receives the logical pages of the print job in the modified order. At step 210, RIP system 110 assembles sheet sides using the media information as the logical pages are received in the modified order. And, at step 212, print engine 112 marks physical media as sheets are assembled and sent by print controller 104.

In method 200, print order processor 108 may direct components of print controller 104 to iteratively request, communicate, and rasterize logical pages in the desired abnormal order by referring to the job model that captures the relationship of logical pages to sheet sides for the print job. As sheet sides are assembled with rasterized pages in abnormal order based on the job model, sheet sides may be immediately sent to print engine 112 for printing as the next sheet is constructed with the following abnormally ordered rasterized pages. Therefore, in method 200, the print job is not rasterized in its entirety before printing is initiated at print engine 112 in the requested abnormal order. Thus, print order processor 108 enables printing in an abnormal printer order without processing/printing delay associated with rasterizing the entire print job before sending sheet sides to print engine 112 or storing print job in a print spool.

In one embodiment, print order processor 108 performs, or directs preprocess system 106 to perform, compression of media information in the job ticket and/or media information determined during processing of print data (e.g., pagination) with a compression algorithm. Compressed media information reduces the data size of job model information for efficient communication between components of print controller 104 during processing of the print job. Media information, such as the size, type, color, and weight, may be substantially consistent throughout a print job and therefore significant data reduction may be realized for large print jobs with relatively uniform media characteristics. The compression algorithm may be implemented with Run Length Encoding (RLE) or other suitable compression algorithms by matter of design choice.

In another embodiment, print order processor 108 forwards compressed media information along with the first page of the requested abnormal order (e.g., last page in the received print job in the case of a reverse order) to RIP system 110. In response to receiving the first page of the abnormal order, RIP system 110 builds job model information in normal order (e.g., builds job model from page 1 to N) using the compressed media information, then rasterizes the first page of the abnormal order, and assembles a last sheet side using the available map in the job model. As pages are received at the RIP system 110 in the requested abnormal order, RIP system 110 iterates the process by referring to the job model information for appropriate placement of rasterized logical pages onto sheet sides. When a sheet is assembled with one or more ripped page(s) in accordance with the job model, the sheet it is delivered to print engine 112. Thus, processing of an abnormal order print job is performed on-the-fly with efficient transmission of media information.

In another embodiment, print order processor 108 is configured to manage interpretive data streams, such as PostScript. PostScript is a page description language (PDL) that uses a preamble to define page layout parameters for individual pages that a print job may reference. As such, print controller 104 may be configured with a PostScript interpreter configured to process and produce bitmaps for an interpretive data stream as part of a parallel RIP system in print controller 104. The PostScript interpreter segments a job file into page segments and appends the preamble to each page segment to enable individual RIP processes to interpret the page segments in parallel. Print order processor 108 is configured with the PostScript interpreter to send the preamble and page segments to the RIP system 110 in the desired abnormal order (e.g., reverse order). The RIP system 110 uses the preamble to build job model information in normal order, and sends page segments and the entire job content to the individual RIP processes in abnormal order to achieve printing in the desired abnormal order. By including the entire job content along with each page segment, individual RIP processes are able to determine the context of the page segment within the print job so that the print job is rasterized, assembled, dispatched, and printed in accordance with the abnormal order in a manner similar to that already described above. Functionality for page description languages other than PostScript may be implemented in print controller 104 by matter of design choice.

### Examples

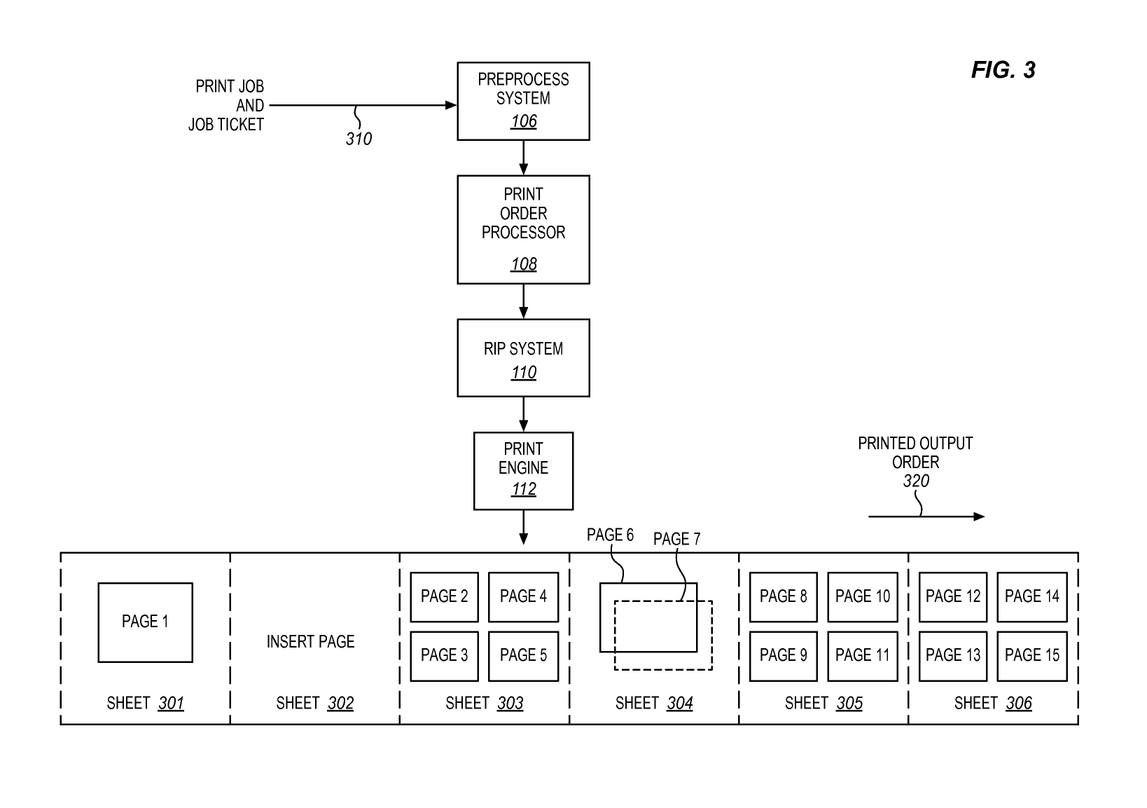

FIG. 3 illustrates an exemplary print job for printing in a reverse order. Assume, for this example, that print controller 104 receives print job 310 to eventually be printed in the reverse order shown in the printed output order 320. Further assume that print job includes fifteen logical pages with a variety of media characteristics described in an associated job ticket. In this example, media information in the job ticket specifies 4-up printing, with exceptions that page 1 is to be printed in 1-up format and pages 6-7 are to be printed in duplex. Additionally, the job ticket specifies an insert sheet is to be attached after page 1.

In the printed output order 320 shown in FIG. 3, sheet 306 (i.e., the last sheet in the print job) is printed by print engine 112 first. Though print job 310 in this example includes several media variations with few pages for explanatory purposes, it will be appreciated that media variations, N-up configurations, insert pages, etc. throughout a print job adds to the complexity of determining which logical pages are to be printed on the sheet sides in a reverse order. As such, in prior systems, in order to be able to determine that pages 12-15 are included in the sixth sheet, pages 1-11 are ripped in normal order for placement on the first five sheets (i.e., sheets 301-305). As already discussed, rasterizing logical pages and assembling sheets in normal order incurs delay for reverse order printing due to rasterizing/storing data in a rip spool.

Thus, print order processor 108 compresses media information collected from print job 310 and job ticket, and sends the compressed media information and the last page (i.e., page 15) to the RIP system 110. RIP system 110 uses the compressed media information to build a job model in normal order. In other words, before rasterization begins, RIP system 110 estimates that received page 15 is to be included on a sixth sheet side according to the mapping in the job model. Thus, RIP system 110 (or one of a plurality of rasterizer components therein) requests sheet 306 from the job model and rips page 15 onto sheet 306. As pages 14, 13, and 12 are sent in reversed order to rasterizing components of the RIP system 110, RIP system 110 refers to the job model to determine that sheet 306 is assembled and ready to be dispatched to print engine 312 to be printed first. In similar fashion, pages 11, 10, 9, and 8 are rasterized onto sheet 305 which is printed at print engine 112 second.

When RIP system 110 receives page 7, it determines from the produced job model to request/retrieve sheet 304 and to rasterize pages 7 and 6 for assembly in duplex format. Pages 5, 4, 3, 2 are received, ripped, and assembled next to be printed fourth. The job model information indicates sheet 302 is an insert sheet. And, sheet 301 is printed last with page 1 in 1-up format. Thus, reverse order printing of print job 310 is achieved without using a rip spool to store the entire rasterized print job.

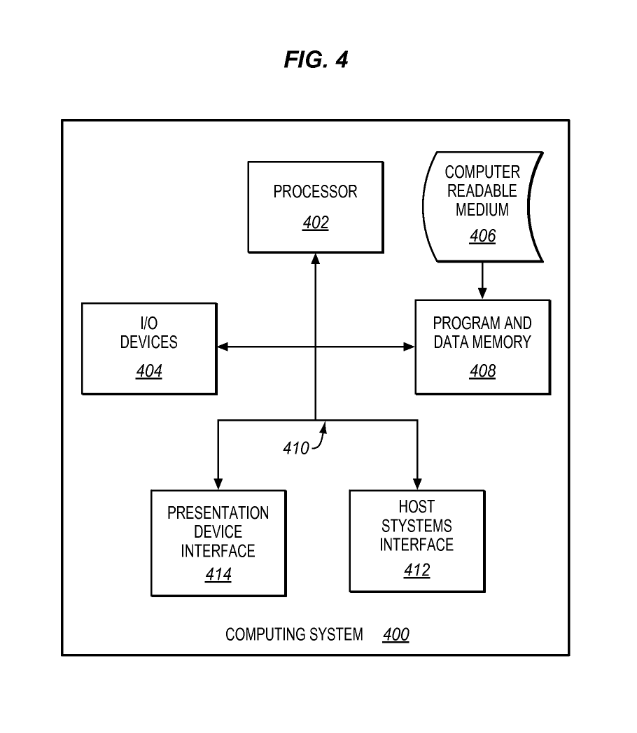

Embodiments disclosed herein can take the form of software, hardware, firmware, or various combinations thereof. In one particular embodiment, software is used to direct processing system(s) of the print controller 104 to perform the various operations disclosed herein. FIG. 4 illustrates a computing system 400 configured to execute a computer readable medium embodying programmed instructions to perform desired functions in an exemplary embodiment. Computing system 400 is configured to perform the above operations by executing programmed instructions tangibly embodied on computer readable medium 406. In this regard, embodiments can take the form of a computer program accessible via computer-readable medium 406 providing program code for use by a computer or any other instruction execution system. For the purposes of this description, computer readable storage medium 406 can be anything that can contain or store the program for use by the computer.

Computer readable medium 406 can be an electronic, magnetic, optical, electromagnetic, infrared, or semiconductor device. Examples of computer readable storage medium 406 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD. Computing system 400, being suitable for storing and/or executing the program code, includes at least one processor 402 coupled to program and data memory 408 through a system bus 410. Program and data memory 408 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 404 (including but not limited to keyboards, displays, pointing devices, etc.) can be coupled either directly or through intervening I/O controllers. Host system interfaces 412 may also be integrated with the system to enable computing system 400 to become coupled to other data processing systems or storage devices through intervening private or public networks. Modems, cable modems, SCSI, Fibre Channel, and Ethernet cards are just a few of the currently available types of network or host interface adapters. Presentation device interface 414 may be integrated with the system to interface to one or more presentation devices, such as printing systems and displays for presentation of presentation data generated by processor 402. Although specific embodiments were described herein, the scope of the inventive concept(s) is not limited to those specific embodiments. The scope of the inventive concept(s) is defined by the following claims and any equivalents thereof.

We claim:

1. An apparatus for abnormal order printing comprising:
a preprocess system of a print controller configured to receive a print job;
a print order processor configured to determine a modified print order of logical pages for the print job, wherein the modified print order is a different order than a normal order of consecutively increasing integers that represent the logical pages;
a RIP system configured to receive media information included in a job ticket for the print job that maps the logical pages to sheet sides in an N-up configuration for the print job, to receive the logical pages of the print job in the modified order, and to assemble sheet sides according to the N-up configuration in the media information as the logical pages are received in the modified order, wherein N is greater than one; and
a print engine configured to receive the sheet sides, and to mark physical media based on the sheet sides.

2. The apparatus of claim 1 wherein:
the print order processor configured to analyze the job ticket for the print job for the media information, to direct a compression of the media information in the preprocess system, and to send the compression to the RIP system; and
the RIP system configured to build job model information based on the compression for mapping the logical pages to the sheet sides, and to iteratively rasterize the logical pages in the modified order based on the mapping.

3. The apparatus of claim 2 wherein:
the RIP system configured to build the job model information in the normal order.

4. The apparatus of claim 2 wherein:
the print order processor configured to perform compression with Run Length Encoding (RLE).

5. The apparatus of claim 1 wherein:
the print job comprises a PostScript data stream;
the print controller configured with a PostScript interpreter to segment pages of the PostScript data stream, and to send segmented pages and a preamble for the PostScript data stream to the RIP system in the modified order.

6. The apparatus of claim 5 wherein:
the RIP system configured to build job model information based on the preamble, and to rasterize the page segments in the modified order.

7. The apparatus of claim 6 wherein:
the RIP system configured to send each page segment along with the PostScript data stream to individual RIP processors to enable parallel rasterizing.

8. A method comprising:
receiving a print job at a preprocess system of a print controller;
determining a modified print order of logical pages for the print job, wherein the modified print order is a different order than a normal order of consecutively increasing integers that represent the logical pages;
receiving, at a Raster Image Processor (RIP) component of the print controller, media information included in a job ticket for the print job that maps the logical pages to sheet sides in an N-up configuration for the print job, wherein N is greater than one;
receiving the logical pages of the print job at the RIP component in the modified order;
assembling sheet sides according to the N-up configuration in the media information as the logical pages are received at the RIP component in the modified order; and
marking the sheet sides to physical media with a print engine.

9. The method of claim 8 further comprising:
receiving the job ticket for the print job;
analyzing the job ticket for the print job for the media information;
compressing the media information;
sending the compressed media information to the RIP system; and
building job model information based on the compression for mapping the logical pages to the sheet sides; and
iteratively rasterizing the logical pages in the modified order based on the mapping.

10. The method of claim 9 further comprising:
building the job model information in the normal order.

11. The method of claim 10 further comprising:
performing compression with Run Length Encoding (RLE).

12. The method of claim 8 further comprising:
segmenting pages of a PostScript data stream; and
sending segmented pages and a preamble for the PostScript data stream to the RIP system in the modified order.

13. The method of claim 12 comprising:
building job model information based on the preamble; and
rasterizing the page segments in the modified order.

14. A non-transitory computer readable medium embodying programmed instructions, which, when executed by a processor, are operable for performing a method comprising:
receiving a print job at a preprocess system of a print controller;
determining a modified print order of logical pages for the print job, wherein the modified print order is a different order than a normal order of consecutively increasing integers that represent the logical pages;
receiving, at a Raster Image Processor (RIP) component of the print controller, media information included in a job ticket for the print job that maps the logical pages to sheet sides in an N-up configuration for the print job, wherein N is greater than one;
receiving the logical pages of the print job at the RIP component in the modified order;
assembling sheet sides according to the N-up configuration the media information as the logical pages are received at the RIP component in the modified order; and
marking the sheet sides to physical media with a print engine.

15. The medium of claim 14, wherein the method further comprises:
receiving the job ticket for the print job;
analyzing the job ticket for the print job for the media information;
compressing the media information;
sending the compressed media information to the RIP system; and
building job model information based on the compression for mapping the logical pages to the sheet sides; and
iteratively rasterizing the logical pages in the modified order based on the mapping.

16. The medium of claim 15, wherein the method further comprises:
building the job model information in the normal order.

17. The medium of claim 16, wherein the method further comprises:
performing compression with Run Length Encoding (RLE).

18. The medium of claim 14, wherein the method further comprises:
segmenting pages of a PostScript data stream; and
sending segmented pages and a preamble for the PostScript data stream to the RIP system in the modified order.

19. The medium of claim 18, wherein the method further comprises:
building job model information based on the preamble; and
rasterizing the page segments in the modified order.

20. The medium of claim 19, wherein the method further comprises:
sending each page segment along with the PostScript data stream to individual RIP processors to enable parallel rasterizing.
